(19) United States
(12) Patent Application Publication
(10) Pub. No.: US 2009/0080209 A1
(43) Pub. Date: Mar. 26, 2009

(54) Colored and electroplated reflective vehicle lamp

(75) Inventor: Tsung-Yen Hu, Tainan City (TW)

Correspondence Address: Tsung-Yen Hu, P.O. BOX 90, Tainan City, 70499, TW

(73) Assignee: LUCIDITY ENTERPRISE CO., LTD.

(21) Appl. No.: 11/902,372

(22) Filed: Sep. 21, 2007

(51) Int. Cl. F21V 7/04

(52) U.S. Cl. 362/518

(57) ABSTRACT

A colored and electroplated reflective vehicle lamp includes a reflecting shield provided with a plurality of bowl-shaped cavities with reflecting surfaces respectively electroplated with a silvery reflecting layer. Then, the silvery reflecting layer is coated thereon with a clear lacquer layer having its surface sprayed with a colored layer. A transparent lamp lens covers the reflecting shield. By the colored reflecting shield and the transparent lamp lens, it is possible to maintain the color gradations and brightness of light illuminated by the vehicle lamp for matching with different colors of vehicles.

### BACKGROUND OF THE INVENTION

1. Field of the Invention

This invention relates to a colored and electroplated reflective vehicle lamp, particularly the one which can maintain the color gradations and brightness of light illuminated by a vehicle lamp and match with different colors of vehicles.

2. Description of the Prior Art

Generally, the color gradations and brightness of light illuminated by a vehicle lamp must conform to requirements of regulations. A conventional vehicle lamp 1, as shown in FIGS. 1 and 2, is provided with a lamp housing 10 installed with a reflecting shield 11 formed with a plurality of cavities 12 respectively having the wall surface electroplated with a silvery reflecting layer 13 for reflecting light. An LED 14 is installed in each cavity 12 of the reflecting shield 11, and the light emitted by the LED 14 is refracted outward by the reflecting shield 11. A lamp lens 15 is secured on the lamp housing 10 and covering the reflecting housing 11. Since the reflecting layer 13 of the reflecting housing 11 is single silvery color; therefore, if the lamp lens 15 of the vehicle lamp 1 is transparent, the color of light illuminated by the vehicle lamp 1 will become extremely monotonous and unable to match up with different colors of vehicles to harmoniously present an integral color of the vehicle. Although the lamp lens 15 can be provided with different colors like red, yellow, etc. for matching with different colors of vehicles, yet such a colored lamp lens 15 may lower effect of light transmission, and the color gradations and brightness of light emitted by the LED 14 will not meet requirements of regulations.

### SUMMARY OF THE INVENTION

The objective of this invention is to offer a colored and electroplated reflective vehicle lamp which can maintain the color gradations and brightness of light illuminated by the vehicle lamp for matching with different colors of vehicles.

The colored and electroplated reflective vehicle lamp in the present invention includes a lamp housing provided with a reflecting shield formed with a plurality of cavities having their wall surfaces respectively disposed with a wave-shaped reflecting surface for reflecting light. Each cavity of the reflecting shield is installed therein with an LED, and the reflecting shield is able to refract outward the bright light emitted by the LED. A transparent lamp lens is fixed on the lamp housing and covers the reflecting shield.

The feature of this invention is that the reflecting surfaces of the reflecting shield are respectively electroplated with a silvery reflecting layer coated thereon with a clear lacquer layer and sprayed with a colored layer; and the lamp lens is transparent.

### BRIEF DESCRIPTION OF DRAWINGS

This invention will be better understood by referring to the accompanying drawings, wherein:

FIG. 1 is a perspective view of a conventional vehicle lamp;

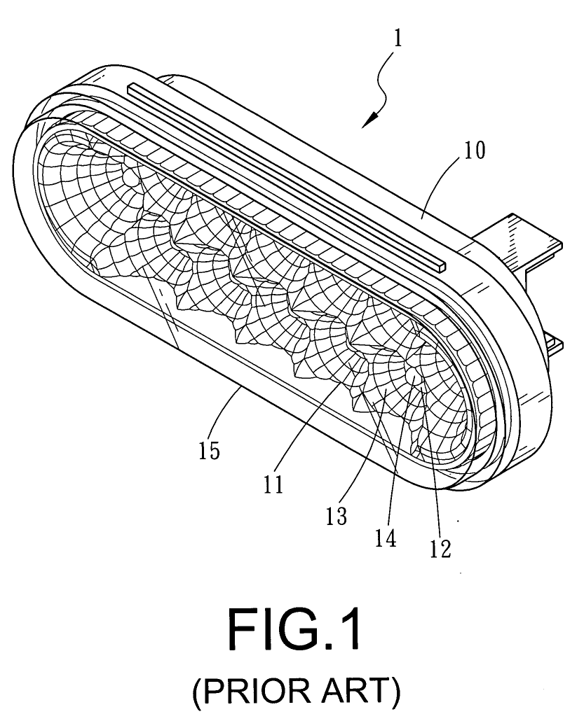

FIG. 2 is a partial magnified cross-sectional view of the conventional reflecting shield;

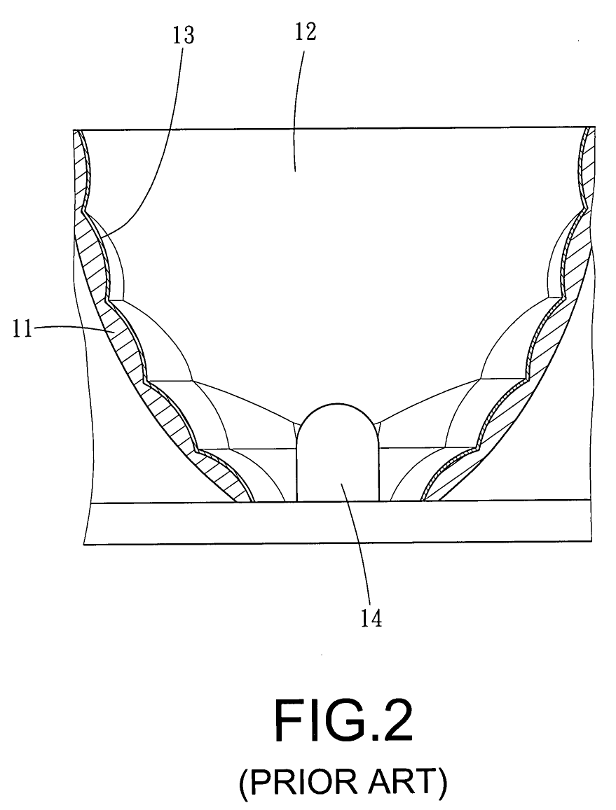

FIG. 3 is a perspective view of a colored and electroplated reflective vehicle lamp in the present invention;

FIG. 4 is a process flow chart of producing a reflecting shield in the present invention; and

FIG. 5 is a partial magnified cross-sectional view of the reflecting shield in the present invention.

### DETAILED DESCRIPTION OF THE PREFERRED EMBODIMENT

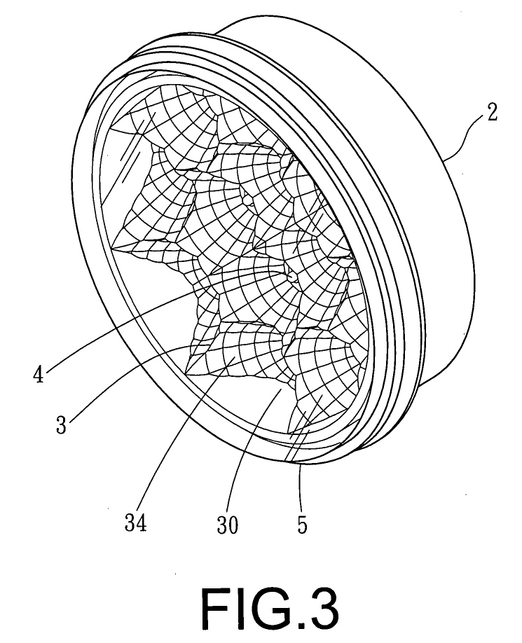

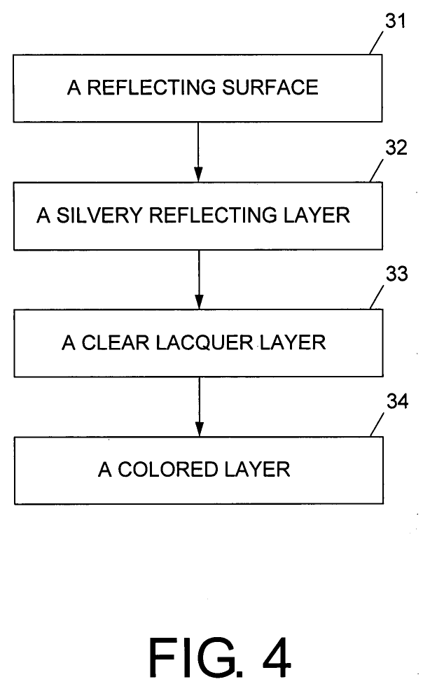

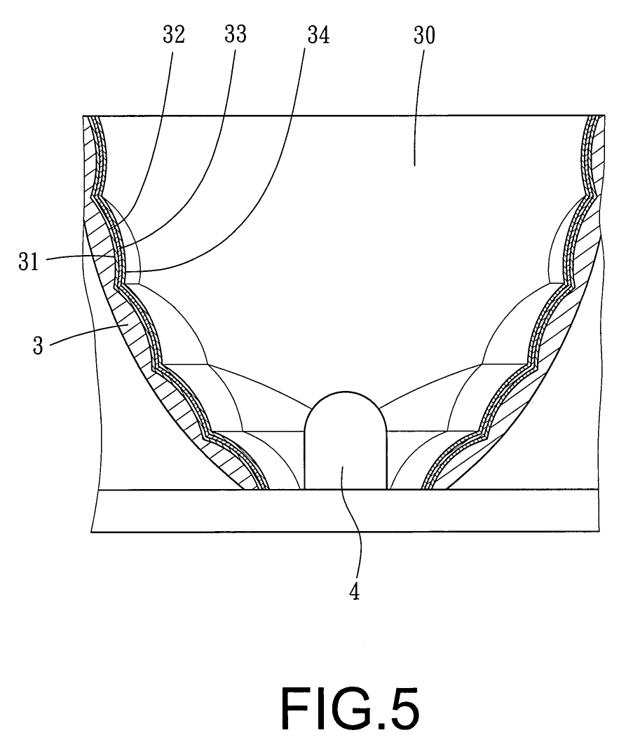

A first preferred embodiment of a colored and electroplated reflective vehicle lamp in the present invention, as shown in FIGS. 3, 4 and 5, includes a lamp housing 2, a reflecting shield 3, plural LEDs 4 and a lamp lens 5 combined together.

The reflecting shield 3 is fixed on the lamp housing 2 and disposed with a plurality of bowl-shaped cavities 30 having their wall surfaces respectively formed with a wave-shaped reflecting surface 31 for reflecting light. The reflecting surface 31 is first electroplated with a silvery reflecting layer 32, and then the silvery reflecting layer 32 is coated thereon with a clear lacquer layer 33. Subsequently, the clear lacquer layer 33 has its surface sprayed with a colored layer 34, which can be provided with various colors for matching with different colors of vehicles.

The LEDs 4 are respectively installed in the cavities 30 of the reflecting shield 3 so that bright light emitted by the LEDs 4 can be refracted outward via the reflecting shield 3.

The lamp lens 5 is a transparent lens fixed on the housing 2 and covering the reflecting shield 3.

The reflecting surfaces 31 of the reflecting shield 3 can be provided with different colors to match with different-colored vehicles for making an integral color of a vehicle harmonious and beautiful. Further, the lamp lens 5 is transparent so colorful light emitted by the LEDs 4 can directly be transmitted out through the lamp lens 5 that will never weaken the brightness and color gradations of light. Furthermore, the colored layer 34 provided on the reflecting surface 31 will not affect reflecting effect of the reflecting surface 31, but maintain the color gradations and brightness of light illuminated out by the vehicle lamp, and the different-colored reflecting shield 3 of the vehicle lamp can be optionally selected for matching with different-colored vehicles to decorate the vehicle.

While the preferred embodiment of the invention has been described above, it will be recognized and understood that various modifications may be made therein and the appended claims are intended to cover all such modifications that may fall within the spirit and scope of the invention.

What is claimed is:

1. A colored and electroplated reflective vehicle lamp comprising a lamp housing, said lamp housing provided thereon with a reflecting shield, said reflecting shield disposed with a plurality of bowl-shaped cavities, each said cavity formed with a wave-shaped reflecting surface for reflecting light, each said cavity of said reflecting shield installed therein with an LED, said reflecting shield refracting outward bright light emitted by said LED, a lamp lens fixed on said lamp housing and covering said reflecting shield; and
Characterized by said reflecting surface of said reflecting shield electroplated thereon with a silvery reflecting layer, said reflecting layer coated thereon with a clear lacquer layer, said clear lacquer layer having its surface sprayed with a colored layer, said lamp lens being transparent.
